(19) United States
(12) Patent Application Publication
(10) Pub. No.: US 2016/0170552 A1
(43) Pub. Date: Jun. 16, 2016

(54) PROCESSING METHOD FOR TOUCH SIGNAL AND COMPUTER SYSTEM THEREOF

(71) Applicant: ELAN MICROELECTRONICS CORPORATION, HsinChu (TW)

(72) Inventors: Jian-Wei Chen, New Taipei City (TW); Ying-Chieh Chuang, Taipei City (TW); Jiun-Hua Chiu, New Taipei City (TW)

(21) Appl. No.: 14/855,399

(22) Filed: Sep. 16, 2015

Related U.S. Application Data
(60) Provisional application No. 62/090,375, filed on Dec. 11, 2014.

(30) Foreign Application Priority Data
May 8, 2015 (TW) 104114649

(51) Int. Cl. G06F 3/041; G06F 3/044; G06F 3/0488

(52) U.S. Cl. CPC G06F 3/0416; G06F 3/04883; G06F 3/044

(57) ABSTRACT

A processing method for touch signals includes receiving at least one touch signal packet, wherein the at least one touch signal packet is generated in response to operations of at least one object on a touch device, performing a determination process according to at least one of the at least one touch signal packet and an application program being executed in a computer system, and providing at least one first packet to a first driver or providing at least one second packet to a second driver according to a determination result of the determination process, wherein when receiving the at least one first packet, the first driver generates a first command according to the at least one first packet, and when receiving the at least one second packet, the second driver generates a second command according to the at least one second packet.

### CROSS REFERENCE TO RELATED APPLICATIONS

This application claims the priority of U.S. Provisional Application No. 62/090,375, filed Dec. 11, 2014, which is included herein by reference.

### BACKGROUND OF THE INVENTION

1. Field of the Invention

The present invention relates to a processing method and a computer system, and more particularly, to a processing method capable of selecting the proper driver for processing touch signals based on current usage situation, and a computer system thereof.

2. Description of the Prior Art

Various electronic devices equipped with touch input interface, such as notebooks, smart phones, personal digital assistants (PDAs), tablet PCs, are widely used in the daily life. The touch input functions provide a natural and intuitive way for users to interact with computers. Touch devices are capable of sensing actions or gestures, and generating corresponding touching signals. As the gestures become richer and more complex, the architecture of processing touching signals has to be improved for providing better performance.

### SUMMARY OF THE INVENTION

It is therefore an objective of the present invention to provide a processing method and a computer system capable of selecting the driver for processing touch signals, to solve the problems in the prior art.

The present invention discloses a processing method for touch signals, comprising: receiving at least one touch signal packet, wherein the at least one touch signal packet is generated in response to operations of at least one object on a touch device; performing a determination process according to at least one of the at least one touch signal packet and an application program being executed in a computer system; and providing at least one first packet to a first driver or providing at least one second packet to a second driver according to a determination result of the determination process; wherein when receiving the at least one first packet, the first driver generates a first command according to the at least one first packet, and when receiving the at least one second packet, the second driver generates a second command according to the at least one second packet.

The present invention further discloses a computer system, comprising: a touch device, for generating at least one touch signal packet in response to operations of at least one object; a first driver; a second driver, provided by an operating system of the computer system; and a processing unit, coupled to the first driver and the second driver, for receiving the at least one touch signal packet and performing a determination process according to at least one of the at least one touch signal packet and an application program being executed in the computer system, wherein a determination result of the determination process is utilized for deciding to output at least one first packet to the first driver or output at least one second packet to the second driver, wherein the contents of the at least one first packet and the at least one second packet relate to the content of the at least one touch signal packet; wherein when receiving the at least one first packet, the first driver generates a first command according to the at least one first packet, and when receiving the at least one second packet, the second driver generates a second command according to the at least one second packet.

The present invention further discloses a processing method for touch signals, comprising: a) receiving operations of at least one object on a touch device; b) determining that a first driver or a second driver generates a command corresponding to the operations according to at least one of the operations and an application program being executed in a computer system; and c) performing an action upon the application program according to the operations.

The present invention further discloses a computer system, comprising: a touch device, for receiving operations of at least one object; a first driver; a second driver, provided by an operating system of the computer system; a processing unit, coupled to the first driver and the second driver, for determining that the first driver or the second driver generates a command corresponding to the operations according to at least one of the operations and an application program being executed in the computer system; and a performing unit, for performing an action upon the application program according to the command.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a computer system according to an exemplary embodiment of the present invention.

FIG. 2 is a flow diagram of a procedure according to an exemplary embodiment of the present invention.

FIG. 3 is a schematic diagram of selecting driver according to an exemplary embodiment of the present invention.

FIG. 4 is a schematic diagram of a computer system according to another exemplary embodiment of the present invention.

FIG. 5 is a flow diagram of a procedure according to another exemplary embodiment of the present invention.

### DETAILED DESCRIPTION

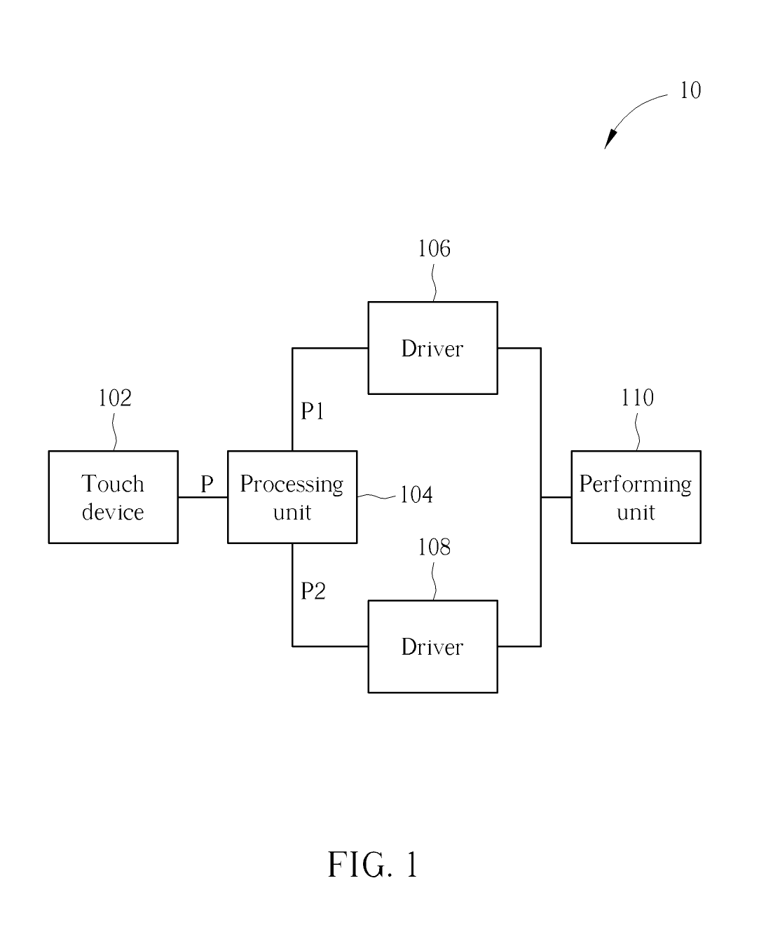

Please refer to FIG. 1, which is a schematic diagram of a computer system 10 according to an exemplary embodiment of the present invention. The computer system 10 includes a touch device 102, a processing unit 104, drivers 106 and 108, and a performing unit 110. The touch device 102 generates at least one touch signal packet P in response to at least one object. The at least one touch signal packet P is in response to operations of at least one object operating on the touch device 102. The touch device 102 can be connected to the processing unit 104 via a wireless or a wired connection. The touch device 102 may continue to send the touch signal packet P. The touch signal packet P may include touch information (e.g., coordinates of touch location of touch object, sensing value of touch object, the number of touch object). The touch device 102 can be a capacitive touch module including a touch input interface connected to a controller (not shown in figures). The controller detects objects acting on the touch input interface and accordingly generates the corresponding touch signal packet P. In this embodiment, the driver 108 may be a driver program, built-in to the operating system, provided by the operating system of the computer system 10. The driver 106 may be a driver program, plugged-in the operating system, provided by a provider of the touch device 102. In another embodiment, the drivers 106 and 108 may be two driver programs which are built-in to the operating system. Or, the drivers 106 and 108 may be two driver programs which are plugged-in the operating system. The processing unit 104 is coupled to the drivers 106 and 108 for performing a determination process and accordingly determining whether at least one first packet P1 is outputted to the driver 106 or whether at least one second packet P2 is outputted to the driver 108. The content of the first packet P1 relates to the content of the touch signal packet P. The content of the second packet P2 relates to the content of the touch signal packet P. For example, the first packet P1 may have the same content as the touch signal packet P. The second packet P2 may have the same content as the touch signal packet P. That is, the processing unit 104 may receive the touch signal packet P and forward the touch signal packet P to the driver 106 or the driver 108. In another embodiment, part of the content of the first packet P1 may be identical to part of the content of the touch signal packet P. Part of the content of the second packet P2 may be identical to part of the content of the touch signal packet P. That is, the processing unit 104 may receive the touch signal packet P and perform a packet processing procedure on the touch signal packet P so as to generate the first packet P1 or the second packet P2. For example, the packet processing procedure may include adding touch information into the touch signal packet P or removing touch information from the touch signal packet P. The packet processing procedure may include changing formats of the touch signal packet P. The touch signal packet P and the first packet P1 (or the touch signal packet P and the second packet P2) may include some identical touch information e.g., identification of touch object (e.g., Identification code of finger), coordinates of touch object, type of touch object.

When the driver 106 receives the first packet P1, the driver 106 generates a first command according to the first packet P1. When the driver 108 receives the second packet P2, the driver 108 generates a second command according to the second packet P2. Moreover, the performing unit 110 performs an action upon an application program being executed in the computer system 10 according to the first command or the second command.

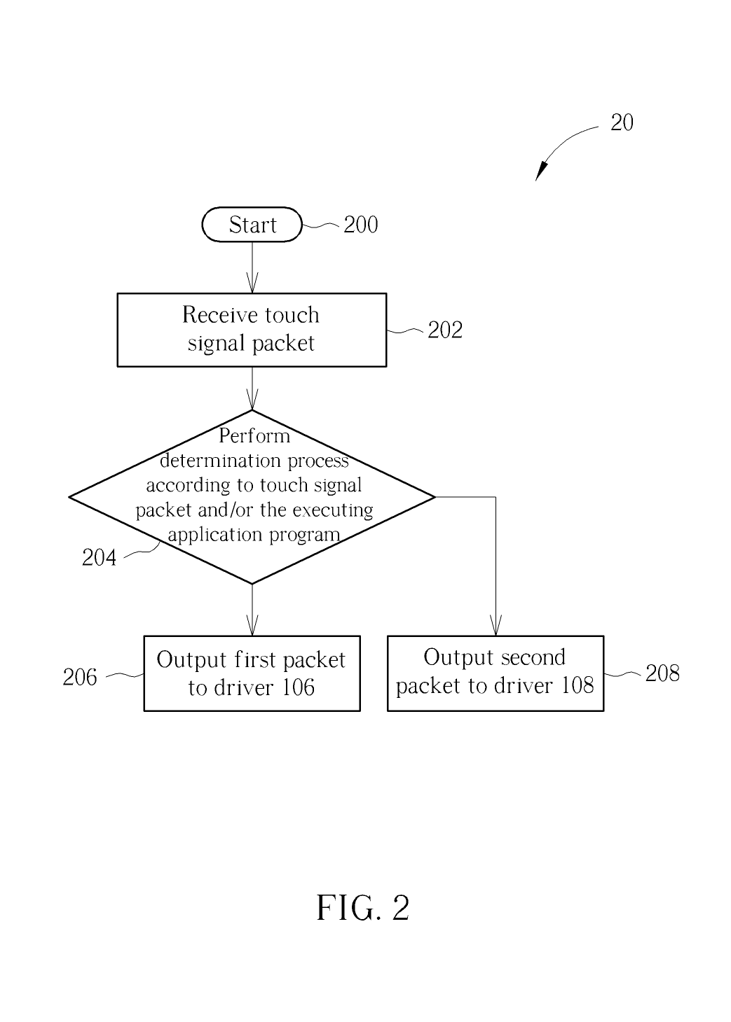

For an illustration of the operations of the processing unit 104, please refer to FIG. 2. FIG. 2 is a flow diagram of a procedure 20 according to an exemplary embodiment of the present invention. According to the procedure 20, when a user utilizes objects, e.g., stylus pens, fingers, palms, cheeks, to contact on the touch device 102, the touch device 102 detects operations of the objects and generates corresponding touch signal packet P accordingly. The touch signal packet P can be send to the processing unit 104. In Step 202, the processing unit 104 receives the touch signal packet P from the touch device 102. In Step 204, the processing unit 104 performs a determination process according to the touch signal packet P and/or an application program which is being executed in the computer system 10. The processing unit 104 decides to output the first packet P1 to the driver 106 (Step 206) or output the second packet P2 to the driver 108 (Step 208) according to a determination result of the above-mentioned determination process. Moreover, the driver 106 receives the first packet P1 and accordingly generates the first command. The driver 108 receives the second packet P2 and accordingly generates the second command. In other words, the processing unit 104 can decide to send the first packet P1 to the driver 106 or send the second packet P2 to the driver 108 provided by the operating system of the computer system 10 for generating corresponding command.

In one embodiment, the driver 106 or the driver 108 interprets user's gestures according to contents of the received packet and generates corresponding command according to the interpreted gestures. In another embodiment, the processing unit 104 interprets user's gestures according to the touch signal packet P and accordingly provides the first packet P1 or the second packet P2 to the driver 106 or the driver 108. That is, the first packet P1 or the second packet P2 includes user's gesture information. The drivers 106 and 108 can generate the corresponding command according to the gesture information included in the packets.

Moreover, in Step 204, the processing unit 104 can convert the format of the touch signal packet P so as to generate the first packet P1 and/or the second packet P2 after the determination process is performed.

Further description associated with the determination process performed in Step 204 is provided as follows. In an embodiment, the processing unit 104 determines the number of the objects operating on the touch device according to the touch signal packet P and compares the number of the objects with a predetermined value TH so as to generate a comparison result. The processing unit 104 decides whether to output the at least one first packet P1 to the driver 106 or whether to output the at least one second packet P2 to the driver 108 provided by the operating system of the computer system 10 according to the comparison result. In other words, the processing unit 104 can determine that the driver 106 or the driver 108 provided by the operating system generates corresponding command according to the number of the objects operating on the touch device. For example, if the predetermined value TH is 2. When the processing unit 104 determines that the number of the objects which are currently touching on the touch device is equal to or greater than 2, the first packet P1 is outputted to the driver 106. When the processing unit 104 determines that the number of the objects which are currently touching on the touch device is smaller than 2 (e.g., the number of the object is 1, 1<TH=2), the second packet P2 is outputted to the driver 108. That is, via the arrangement of the processing unit, the touch operations acted by two or more fingers may be allocated to the driver 106 for generating corresponding command, and the touch operations acted by single finger may be allocated to the driver 108 for generating corresponding command. For multi-touch processing, a provider of the touch device 102 is generally more familiar with touching operation command services than a provider of the operating system. In such a situation, multi-touch gestures can be processed by the driver 106 developed by a provider of the touch device 102 for providing a better user experience.

In an embodiment, the processing unit 104 determines a gesture according to one or more touch signal packets P. Further, the processing unit 104 determines whether the gesture corresponds to a supportable gesture list of the driver 106, and accordingly decides whether to output at least one first packet P1 to the driver 106. In other words, the processing unit 104 can determine that the driver 106 or the driver 108 provided by the operating system generates corresponding command based on the gesture operated on the touch device 102 by the objects. For example, if the determined gesture matches any of the gestures in the supportable gesture list of the driver 106, the processing unit 104 outputs at least one first packet P1 to the driver 106. As such, the driver 106 generates the first command according to the at least one first packet P1. If the determined gesture does not match to any of the gestures in the supportable gesture list of the driver 106, the processing unit 104 outputs at least one second packet P2 to the driver 108. The driver 108 generates the second command according to the at least one second packet P2. If the driver 108 does not support the gesture determined by the processing unit 104, the driver 108 may ignore the determined gesture operation. For example, the computer system 10 does not respond to the gesture operation. In addition, a supportable gesture list of the driver 106 can be pre-determined and pre-stored. For example, the gestures which are supported by the driver 106 and/or the gestures which need to be processed by the driver 106 can be pre-determined and pre-stored into the supportable gesture list. In another embodiment, the processing unit 104 can determine if the driver 106 or the driver 108 supports the gesture and transmit the packets to the driver which supports the gesture. If neither the driver 106 nor the driver 108 supports the gesture determined by the processing unit 104, the processing unit 104 may ignore the determined gesture operation without further processing.

In an embodiment, after receiving the touch signal packet P, the processing unit 104 determines whether an application program which is being executed in the computer system 10 corresponds to a supportable application program list of the driver 106, and accordingly decides whether to output at least one first packet P1 to the driver 106. In other words, the processing unit 104 can determine that the driver 106 or the driver 108 provided by the operating system processes touch operations to generate corresponding command based on the application program being executed in the computer system 10. For example, if an application program which is being executed in the computer system 10 matches to any of application programs in the supportable application program list of the driver 106. This means that the driver 106 can support the application program being executed in the computer system 10. The processing unit 104 outputs at least one first packet P1 to the driver 106, so that the driver 106 generates the first command according to the at least one first packet P1. If the application program being executed in the computer system 10 does not match to any of the application programs in the supportable application program list of the driver 106, the processing unit 104 outputs at least one second packet P2 to the driver 108. The driver 108 generates the second command according to the at least one second packet P2. In addition, a supportable gesture list of the driver 106 can be pre-determined and pre-stored. In another embodiment, the processing unit 104 can determine if the driver 106 or the driver 108 supports the application program being executed in the computer system 10 and transmit the packets to the driver which supports the application program being executed in the computer system 10. If neither the driver 106 nor the driver 108 supports the application program being executed in the computer system 10, the processing unit 104 may ignore the touch signal packet P without further processing.

In an embodiment, the processing unit 104 determines a type of an object operating on the touch device according to the touch signal packet P and determines whether the type of the object is a first type. The processing unit 104 decides to output the at least one first packet P1 to the driver 106 based on determining that the type of the object is the first type. In other words, the processing unit 104 can determine that the driver 106 or the driver 108 provided by the operating system generates corresponding command according to the type of the object touching on the touch device. For example, if the first type of object is defined as a stylus pen. When the processing unit 104 determines that the object touching on the touch device is a stylus pen, the first packet P1 is outputted to the driver 106. When the processing unit 104 determines that the object touching on the touch device is not a stylus pen, the second packet P2 is outputted to the driver 108. Therefore, the processing unit 104 can determine that the driver 106 or the driver 108 processes the touch operation acting on the touch device 102 by the object according to the type of the object touching on the touch device 102. For example, when the processing unit 104 determines that the object touching on the touch device is a stylus pen, the first packet P1 is outputted to the driver 106. When the processing unit 104 determines that the object touching on the touch device is a finger, the second packet P2 is outputted to the driver 108.

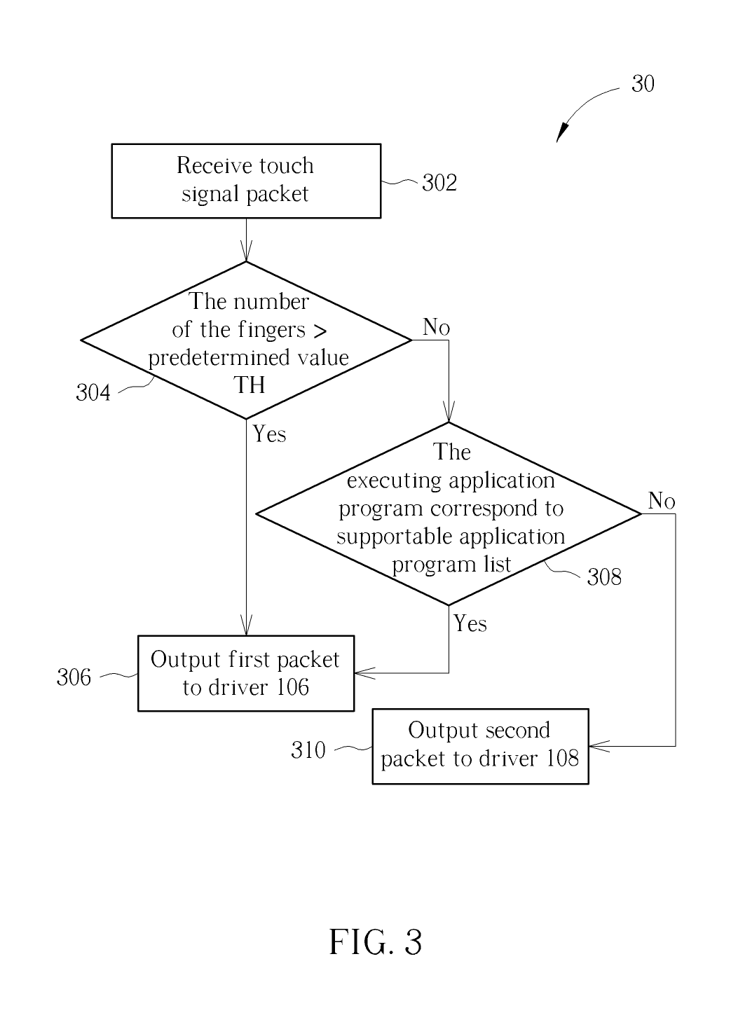

To sum up, as to the determination process performed in Step 204, the processing unit 104 can determine that the driver 106 or the driver 108 provided by the operating system generates the corresponding command according to at least one of the number of objects operating on the touch device 102, the type of objects, the gestures, the application program being executed in the computer system 10 or combinations thereof. For example, please refer to FIG. 3. The processing unit 104 can determine which one of the drivers is selected to generate the corresponding command according to the number of the objects operating on the touch device 102 and the application program being executed in the computer system 10. As shown in FIG. 3, when user's fingers contact and move on the touch device 102, the touch device 102 detects operations of the fingers and generates corresponding touch signal packet P accordingly. In Step 302, the processing unit 104 receives and analyzes one or more touch signal packets P. In Step 304, the processing unit 104 determines whether the number of the fingers which are currently touching on the touch device 102 is greater than a predetermined value TH. If the determination result in Step 304 is yes, go to Step 306; otherwise, go to Step 308. The number of the fingers can be included in the touch signal packet P. The number of the fingers can be determined according to the content of the touch signal packet P by the processing unit 104. In Step 306, the processing unit 104 output at least one first packet P1 to the driver 106. The driver 106 generates the first command according to the at least one first packet P1. In Step 308, the processing unit 104 detects an application program which is being executed in the computer system 10 and determines whether the application program being executed in the computer system 10 corresponds to the supportable application program list of the driver 106. If yes, go to Step 306. If no, go to Step 310. In Step 310, the processing unit 104 output at least one second packet P2 to the driver 108. The driver 108 generates the second command according to the at least one second packet P2.

In brief, the processing unit 104 can decide to send the packet related to the touch signal packet P to the driver 106 or the driver 108 provided by the computer system 10 for generating corresponding command according to the touch signal packet and/or the application program being executed in the computer system 10.

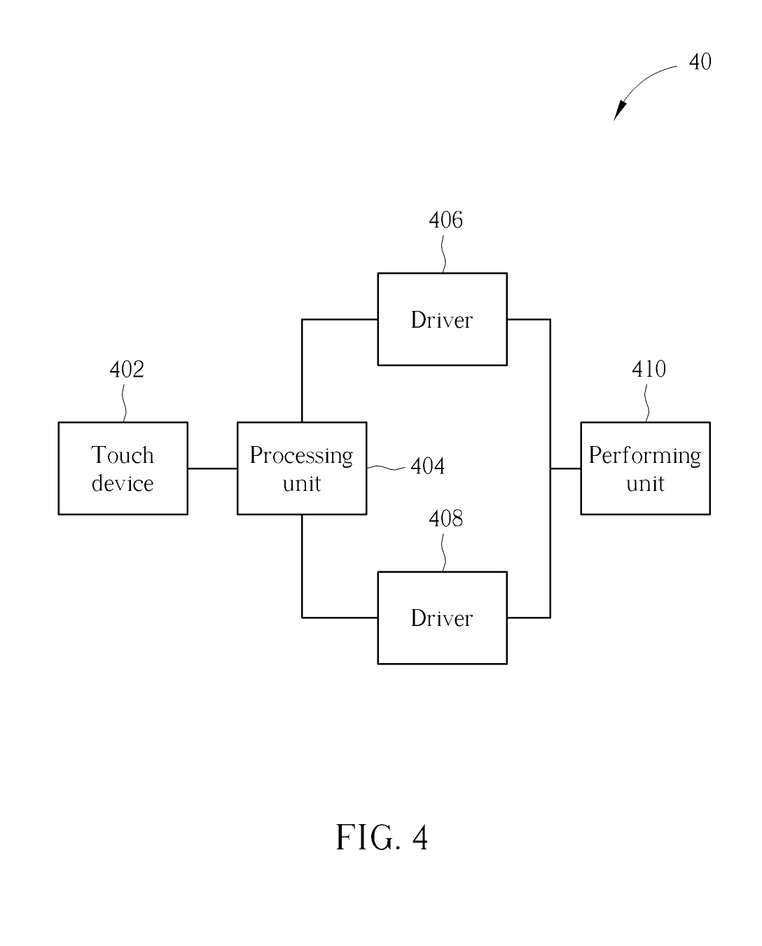

Please refer to FIG. 4, which is a schematic diagram of a computer system 40 according to an exemplary embodiment of the present invention. Note that the units in the computer system 40 shown in FIG. 4 with the same designations as those in the computer system 10 shown in FIG. 1 have similar operations and functions, further description is omitted for brevity. The interconnections of the units are as shown in FIG. 4. The computer system 40 includes a touch device 402, a processing unit 404, drivers 406 and 408, and a performing unit 410. The touch device 402 receives operations of at least one object operating on a touch device. The processing unit 404 is coupled to the drivers 406 and 408 for determining that the driver 406 or the driver 408 generates a command corresponding to the operations. The performing unit 410 performs a hot-key processing upon an application program being executed in the computer system 40 according to the command corresponding to the operations. The application program can be image processing software or office software. The hot-key may be a specific key or a specific combination of keys of a keyboard, which can be used to perform a specific function. The hot-key can be used to perform different functions, such as zooming in, zooming out, enlarging, reducing or turning page for an image or a document. In an embodiment, the performing unit 410 can search for a corresponding hot-key in a hot-key database according to the command and perform a function corresponding to the hot-key. That is, the operations of touching the touch device 402 by the user can be simulated to act as a hot-key and the function of the hot-key can be performed by the computer system 40.

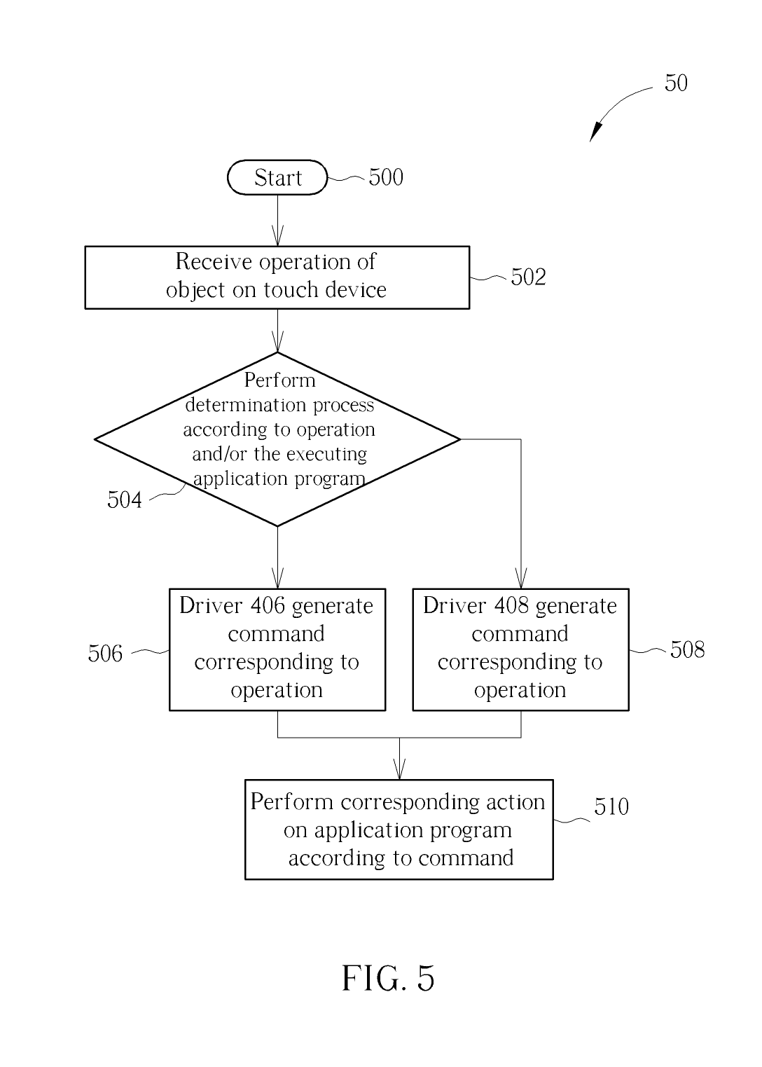

FIG. 5 is a flow diagram of a procedure 50 according to an exemplary embodiment of the present invention. The procedure 50 in FIG. 5 can be applied to the embodiments shown in FIG. 1 or FIG. 4. According to the procedure 50, when a user utilizes at least one touching object to touch on the touch device 402, the touch device 402 receives operations of the at least one touching object (Step 502). The processing unit 404 performs a determination process according to the operations and/or an application program which is being executed in the computer system 40. A determination result of the determination process is utilized for determining that the driver 406 or the driver 408 generates a command corresponding to the operations (Step 504). If the determination result of the determination process represents that the driver 406 generates the command, the driver 406 generates a command corresponding to the operations and sends the command to the performing unit 410 (Step 506). If the determination result of the determination process represents that the driver 408 provided by the operating system of the computer system 40 generates the command, the driver 408 generates a command corresponding to the operations and sends the command to the performing unit 410 (Step 508). Moreover, when receiving the command, the performing unit 410 performs an action upon an application program according to the command (Step 510). In other words, the processing unit 404 can decide that the driver 406 or the driver 408 generates a command corresponding to the operations. Since the objects touching on the touch device, the touch device generates the corresponding the touch signal packet P. Therefore, the technical idea shown in Step 504 of FIG. 5 may be substantially the same as the technical idea shown in Step 204 of FIG. 2.

Further description associated with the determination process performed in Step 504 is provided as follows. In an embodiment, the processing unit 404 determines the number of the objects operating on the touch device 402 according to the operations of the objects on the touch device 402. The processing unit 404 compares the number of the objects with a predetermined value TH so as to generate a comparison result. The processing unit 404 decides decide that the driver 406 or the driver 408 generates a command corresponding to the operations according to the comparison result. In other words, the processing unit 404 can determine that the driver 406 or the driver 408 provided by the operating system generates corresponding command according to the number of the objects touching on the touch device. For example, if the predetermined value TH is 2. When the processing unit 404 determines that the number of the objects touching on the touch device 402 is equal to or greater than 2, the processing unit 404 further determines that the driver 406 generates a command corresponding to the operations. When the processing unit 404 determines that the number of the touching objects is smaller than (e.g. the number of the touching objects is 1, 1<TH=2), the processing unit 404 further determines that the driver 408 generates a command corresponding to the operations. This means, via the arrangement of the processing unit, the touch operations acted by two or more fingers may be allocated to the driver 406 for generating corresponding command, and the touch operations acted by single finger may be allocated to the driver 408 for generating corresponding command. For multi-touch processing, a provider of the touch device 402 is generally more familiar with touching operation command services than a provider of the operating system. In such a situation, multi-touch gestures can be processed by the driver 406 developed by the provider of the touch device 402, so as to provide a better user experience.

In an embodiment, the processing unit 404 determines a gesture corresponding to the operations according to operations of the object operating on the touch device. Further, the processing unit 404 determines whether the gesture corresponds to a supportable gesture list of the driver 406, and accordingly decides whether the driver 406 generates a command corresponding to the operations. In other words, the processing unit 404 can determine that the driver 406 or the driver 408 provided by the operating system generates corresponding command based on the gesture operated on the touch device 402 by the objects. For example, if the determined gesture matches any of the gestures in the supportable gesture list of the driver 406, the driver 406 generates the command corresponding to the operations. If the determined gesture does not match to any of the gestures in the supportable gesture list of the driver 406, the driver 408 generates the command corresponding to the operations. If the driver 408 does not support the gesture determined by the processing unit 404, the driver 408 may ignore the determined gesture operation. For example, the computer system 40 does not respond to the gesture operation. In addition, a supportable gesture list of the driver 406 can be pre-determined and pre-stored. For example, the gestures which are supported by the driver 406 and/or the gestures which need to be processed by the driver 406 can be pre-determined and pre-stored into the supportable gesture list. In another embodiment, the processing unit 404 can determine if the driver 406 or the driver 408 supports the gesture and transmit the packets to the driver which supports the gesture. If neither the driver 406 nor the driver 408 supports the gesture determined by the processing unit 404, the processing unit 404 may ignore the determined gesture operation without further processing.

In an embodiment, the processing unit 404 can determine whether an application program being executed in the computer system 40 corresponds to a supportable application program list of the driver 406, and accordingly decides whether the driver 406 generates a command corresponding to the operations. In other words, the processing unit 404 can determine that the driver 406 or the driver 408 provided by the operating system processes touch operations to generate corresponding command based on the application program being executed in the computer system 40. For example, if an application program which is being executed in the computer system 40 matches to any of application programs in the supportable application program list of the driver 406. This means that the driver 406 can support the application program being executed in the computer system 40. The driver 406 generates a command corresponding to the operations. If the application program being executed in the computer system 40 does not match to any of the application programs in the supportable application program list of the driver 406, the driver 408 generates the command according to the operations. In addition, a supportable gesture list of the driver 406 can be pre-determined and pre-stored. In another embodiment, the processing unit 404 can determine if the driver 406 or the driver 408 supports the application program being executed in the computer system 40 and transmit the packets to the driver which supports the application program being executed in the computer system 40. If neither the driver 406 nor the driver 408 supports the application program being executed in the computer system 40, the processing unit 404 may ignore the touch signal packet P without further processing.

In an embodiment, the processing unit 404 determines a type of an object touching on the touch device according to operations of the object on the touch device 402 and determines whether the type of the object is a first type. The processing unit 404 decides whether the driver 406 generates a command corresponding to the operations based on the type determination result. In other words, the processing unit 404 can determine that the driver 406 or the driver 408 provided by the operating system generates corresponding command according to the type of the object operating on the touch device. In other words, the processing unit 404 can determine that the driver 406 or the driver 408 provided by the operating system would generate corresponding command according to the type of the object touching on the touch device. For example, if the first type of object is defined as a stylus pen. When the processing unit 404 determines that the object touching on the touch device is also a stylus pen, the driver 406 generates a command corresponding to the operations. When the processing unit 404 determines that the object touching on the touch device is not a stylus pen, the driver 408 generates a command corresponding to the operations. Therefore, the processing unit 404 can determine that the driver 406 or the driver 408 processes the touch operation acting on the touch device 402 according to the type of the object touching on the touch device 402. For example, when the processing unit 404 determines that the object touching on the touch device is a stylus pen, the driver 406 generates a command corresponding to the operations. When the processing unit 404 determines that the object touching on the touch device is a finger, the driver 408 generates a command corresponding to the operations. There are different methods of determining the type of the object touching on the touch device. The touch device 402 may determine that the object is a stylus pen based on the contact and/or the movement speed of the object. The touch device 402 may determine that the object is a stylus pen based on the received signal transmitted from an active-type stylus pen.

To sum up, as to the determination process performed in Step 504, the processing unit 504 can determine that the driver 406 or the driver 408 provided by the operating system generates the corresponding command according to at least one of the number of objects operating on the touch device 402, the type of objects, the gestures, the application program being executed in the computer system 40 or combinations thereof.

In the above embodiments, the computer system can be an electronic device equipped with touch input functions, such as a smart phone, a notebook, a tablet computer, a smart TV or a wearable device, but this should not be a limitation of the invention. The touch device can be a touchpad or a touch panel. The touch object can be a stylus pen, a finger, a palm, a cheek, or any other device which can be used to contact on the touch device. The drivers 106 and 406 can be provided by a provider or a manufacturer of the touch device. The drivers 106 and 406 can be plug-in drivers. The drivers 108 and 408 can be provided by the operating system of the computer system.

In summary, the invention can select the driver for generating corresponding command based on the operations of the user on the touch device and the application program being executed in the computer system. That is, the invention can select the proper driver for processing touch signals and generating the corresponding command based on current usage situation, thus optimizing performance of the interactive human-machine interface.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A processing method for touch signals, comprising:
receiving at least one touch signal packet, wherein the at least one touch signal packet is generated in response to operations of at least one object on a touch device;
performing a determination process according to at least one of the at least one touch signal packet and an application program being executed in a computer system; and
providing at least one first packet to a first driver or providing at least one second packet to a second driver according to a determination result of the determination process;
wherein when receiving the at least one first packet, the first driver generates a first command according to the at least one first packet, and when receiving the at least one second packet, the second driver generates a second command according to the at least one second packet.

2. The processing method of claim 1, wherein the first packet is the same as the touch signal packet.

3. The processing method of claim 1, wherein the second packet is the same as the touch signal packet.

4. The processing method of claim 1, further comprising:
converting a format of the touch signal packet to obtain the first packet after the determination process is performed.

5. The processing method of claim 1, wherein the determination process comprising:
determining the number of the objects operating on the touch device according to the touch signal packet; and
comparing the number of the objects with a predetermined value.

6. The processing method of claim 1, wherein the determination process comprising:
determining a gesture according to the touch signal packet; and
determining whether the gesture corresponds to a supportable gesture list of the first driver;
wherein the at least one first packet is provided to the first driver based on determining that the gesture corresponds to the supportable gesture list.

7. The processing method of claim 1, wherein the determination process comprising:
determining whether the application program being executed in the computer system corresponds to a supportable application program list of the first driver;
wherein the at least one first packet is provided to the first driver based on determining that the application program being executed in the computer system corresponds to the supportable application program list.

8. The processing method of claim 1, wherein the determination process comprising:
determining the type of the objects according to the touch signal packet;
wherein the at least one first packet is provided to the first driver based on determining that the type of the objects is a first type.

9. The processing method of claim 1, wherein the touch device is a touch pad or a touch panel.

10. A computer system, comprising:
a touch device, for generating at least one touch signal packet in response to operations of at least one object;
a first driver;
a second driver, provided by an operating system of the computer system; and
a processing unit, coupled to the first driver and the second driver, for receiving the at least one touch signal packet and performing a determination process according to at least one of the at least one touch signal packet and an application program being executed in the computer system, wherein a determination result of the determination process is utilized for deciding to output at least one first packet to the first driver or output at least one second packet to the second driver, wherein the contents of the at least one first packet and the at least one second packet relate to the content of the at least one touch signal packet;
wherein when receiving the at least one first packet, the first driver generates a first command according to the at least one first packet, and when receiving the at least one second packet, the second driver generates a second command according to the at least one second packet.

11. The computer system of claim 10, wherein the first packet is the same as the touch signal packet.

12. The computer system of claim 10, wherein the second packet is the same as the touch signal packet.

13. The computer system of claim 10, wherein the processing unit converts a format of the touch signal packet to generate the first packet after the determination process is performed.

14. The computer system of claim 10, wherein the processing unit determines the number of the objects operating on the touch device according to the touch signal packet, compares the number of the objects with a predetermined value, and accordingly decides to output the at least one first packet to the first driver or output the at least one second packet to the second driver.

15. The computer system of claim 10, wherein the processing unit determines a gesture according to the touch signal packet, determines whether the gesture corresponds to a supportable gesture list of the first driver, and outputs the at least one first packet to the first driver based on determining that the gesture corresponds to the supportable gesture list.

16. The computer system of claim 10, wherein the processing unit determines whether the application program being executed in the computer system corresponds to a supportable application program list of the first driver and outputs the at least one first packet to the first driver based on determining that the application program being executed in the computer system corresponds to the supportable application program list.

17. The computer system of claim 10, wherein the processing unit determines the type of the objects according to the touch signal packet and outputs the at least one first packet to the first driver based on determining that the type of the objects is a first type.

18. The computer system of claim 10, wherein the touch device is a touch pad or a touch panel.

19. A processing method for touch signals, comprising:
a) receiving operations of at least one object on a touch device;
b) determining that a first driver or a second driver generates a command corresponding to the operations according to at least one of the operations and an application program being executed in a computer system; and
c) performing an action upon the application program according to the operations.

20. The processing method of claim 19, wherein the step b) comprises:
determining the number of the objects operating on the touch device and comparing the number of the objects with a predetermined value to generate a comparison result; and
determining that the first driver or the second driver generates the command corresponding to the operations according to the comparison result.

21. The processing method of claim 19, wherein the step b) comprises:
determining a gesture corresponding to the operations;
determining whether the gesture corresponds to a supportable gesture list of the first driver; and
determining that the first driver generates the command corresponding to the operations based on determining that the gesture corresponds to the supportable gesture list.

22. The processing method of claim 19, wherein the step b) comprises:
determining whether the application program being executed in the computer system corresponds to a supportable application program list of the first driver; and
determining that the first driver generates the command corresponding to the operations based on determining that the application program being executed in the computer system corresponds to the supportable application program list.

23. The processing method of claim 19, wherein the step b) comprises:
determining the type of the objects; and
determining that the first driver generates the command corresponding to the operations based on determining that the type of the objects is a first type.

24. The processing method of claim 19, wherein the touch device is a touch pad or a touch panel.

25. A computer system, comprising:
a touch device, for receiving operations of at least one object;
a first driver;
a second driver, provided by an operating system of the computer system;
a processing unit, coupled to the first driver and the second driver, for determining that the first driver or the second driver generates a command corresponding to the operations according to at least one of the operations and an application program being executed in the computer system; and
a performing unit, for performing an action upon the application program according to the command.

26. The computer system of claim 25, wherein the processing unit determines the number of the objects operating on the touch device, compares the number of the objects with a predetermined value to generate a comparison result, and determines that the first driver or the second driver generates the command corresponding to the operations according to the comparison result.

27. The computer system of claim 25, wherein the processing unit determines a gesture corresponding to the operations, determines whether the gesture corresponds to a supportable gesture list of the first driver, and determines that the first driver generates the command corresponding to the operations based on determining that the gesture corresponds to the supportable gesture list.

28. The computer system of claim 25, wherein the processing unit determines whether the application program being executed in the computer system corresponds to a supportable application program list of the first driver and determines that the first driver generates the command corresponding to the operations based on determining that the application program being executed in the computer system corresponds to the supportable application program list.

29. The computer system of claim 25, wherein the processing unit determines the type of the objects and determines that the first driver generates the command corresponding to the operations based on determining that the type of the objects is a first type.

30. The computer system of claim 25, wherein the touch device is a touch pad or a touch panel.
